(19) United States
(12) Patent Application Publication
(10) Pub. No.: US 2009/0256124 A1
(43) Pub. Date: Oct. 15, 2009

(54) DEVICE FOR LAYING CABLE IN A CONDUIT

(75) Inventor: Gerard Plumettaz, Territet-Veytaux (CH)

Correspondence Address: PEARNE & GORDON LLP, 1801 EAST 9TH STREET, SUITE 1200, CLEVELAND, OH, 44114-3108, US

(73) Assignee: PLUMETTAZ SA, Bex, CH (CH)

(21) Appl. No.: 12/374,530

(22) PCT Filed: Jul. 17, 2007
(86) PCT No.: PCT/CH07/00345

§ 371 Date: May 9, 2009

(30) Foreign Application Priority Data
Jul. 24, 2006 (EP) 06405318.4

(51) Int. Cl. H02G 1/08; G02B 6/52

(52) U.S. Cl. 254/134.4

(57) ABSTRACT

The device for installing a wire in a conduit of the type with thin walls and ribbed, comprises in particular a support sleeve suitable for preventing a radial expansion as well as a lengthening of a portion of said conduit above ground.

The content of Application No PCT/CH2007/000345, filed Jul. 17, 2007 in Switzerland is hereby incorporated by reference.

The present invention relates to the technical area of cable installations and the laying of cables, e.g. optical fibre or electric cables, laid inside buried, walled and/or immersed conduits. The term “cables” is also meant to include ducts or others for the transport of power, fluids and electric, light or other signals. The term cable also concerns low, medium and high voltage electric cables, whether single-phase or three-phase.

Different methods are known for laying cables inside buried conduits. Some of these methods are defined below.

By “pulling” is meant that the cable is attached via its end to a winch line already installed in the conduit. This line is fastened to the reel of a winch which winds the line, causing the cable to be laid in the conduit by pulling and sliding said cable inside said conduit.

By “pulling-pushing” is meant simultaneous pulling and pushing using means to push the cable as it enters the conduit, thereby reducing pulling forces on the cable head and increasing the cable laying distance. Additional means for driving the cable, arranged along its pathway, may also be used.

By “blowing” is meant that the conduit is placed under pressure by means of a fluid between the cable feed means and an airtight driver piston attached to the front end of the cable. The pressure prevailing inside the conduit causes forward movement of the piston which pulls with it the front end of the cable. For pressurization generally air is used.

By “blowing-pushing” is meant the use of means allowing the cable to be pushed on entering the conduit, associated with means used for the so-called “blowing” technique. Here again an increase in cable laying distance is achieved.

By “floating-pushing” and/or “carry-pushing” is meant a technique in which a fluid, generally air or water, is injected into the conduit at a speed greater than the speed of advancement of the cable, and it is the friction of the fluid on the outer cladding of the cable which exerts the pulling force.

In some “pull-push” techniques, water is also injected into the conduit. The pulling force is provided by a piston attached to the head end of the cable which is subjected to the pressure of the water injected into the conduit. For this purpose the piston is provided with one or more seals.

One of the advantages of water injection techniques, and techniques injecting other liquids, is the reduction in the bearing load of the cable against the inner wall of the conduit and therefore a reduction in friction loads, a reduction due to the Archimedes force exerted on the cable. The laying distance is limited however by the maximum allowable water pressure applied to the piston, this being determined by the maximum pressure which can be applied to the conduit.

Buried conduits used with water injection techniques are often smooth tubes in extruded PE or PVC. These conduits must have sufficiently thick walls, i.e. 5 to 10% of their diameter for PE, and 4 to 5% of their diameter for PVC directly buried underground, and around 2% of their diameter for concrete-clad PVC conduits, so that they can withstand soil stresses and the water pressure required for cable laying, with the disadvantage of increased costs and reduced laying length compared with conduits having thinner walls.

There are other types of thin-wall conduits and ducts on the market for the laying of buried cables which provide good crush resistance, such as ribbed conduits with twin wall provided with peripheral ribs. Twin-wall ribbed conduits, with respect to their weight per unit length, are much more resistant to compression and crushing than smooth ducts used as conduits for the laying of cables by water injection. Twin-wall ribbed conduits are not designed however for the laying of cables by blowing or float-push techniques, and cannot withstand high pressures inside the conduit.

Considering the thinness of the inner wall of these conduits, any pressurizing of said twin-wall ribbed conduit firstly causes radial expansion of the conduit, possibly leading to tearing thereof, as well as axial expansion causing elongation of the conduit. Said twin-wall ribbed conduits are therefore, in principle, unsuitable for cable laying involving pressurization of said conduit.

The inventor of the present invention has nevertheless ascertained that twin-wall ribbed conduits can be used for laying cables using water-injection pushing techniques, if said conduits are buried. The soil surrounding the conduit firstly prevents radial expansion of the conduit and secondly, by clinging between the ribs on the outside of the conduit, prevents axial expansion and thereby conduit elongation.

However this does not apply to the ends of the conduit sections which are no longer buried and for which special precautions need to be taken to avoid tearing of a conduit rib and/or elongation.

The devices described in patents EP 0 251 129 and DE 197 45 918 are not at all suitable for the utilization concerned herein, since they are solely intended for the laying of cables in smooth buried conduits, and are not provided with any means capable of preventing elongation of the conduit.

One purpose of the invention is to provide a cable laying device to lay cable in a buried conduit, using lightweight ribbed conduits with twin-wall, without compromising laying distance i.e. the length of cable which can be laid in the conduit, whilst ensuring the integrity of the conduit.

It is advantageous to provide a cable laying driver piston which can be used with laying techniques in which a fluid e.g. water is injected into the cable conduit to push said piston.

It is advantageous to provide a laying device which is apt to be used to lay cables with non-circular section, e.g. approximately triangular or square, by reducing and even eliminating fluid leaks.

It is advantageous to provide a system to lay cable in a conduit, which is reliable and economical.

Some purposes of the invention are achieved with a cable laying device such as described in claim 1, particular embodiments or variants being described in the dependent claims.

Other characteristics and advantageous aspects of the invention will also become apparent from the detailed description given below, with reference to the appended drawings in which:

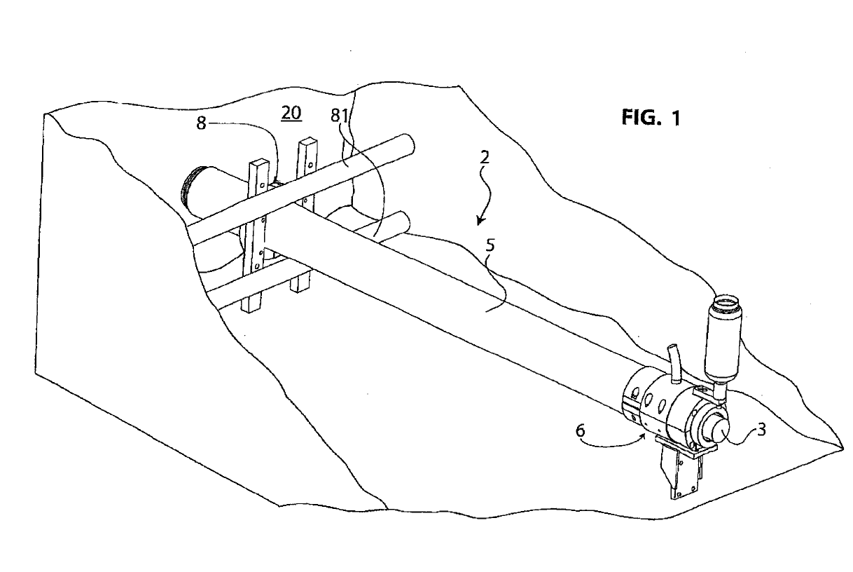

FIG. 1 is a perspective view of an upstream part of the device according to the invention, to lay cable in a conduit.

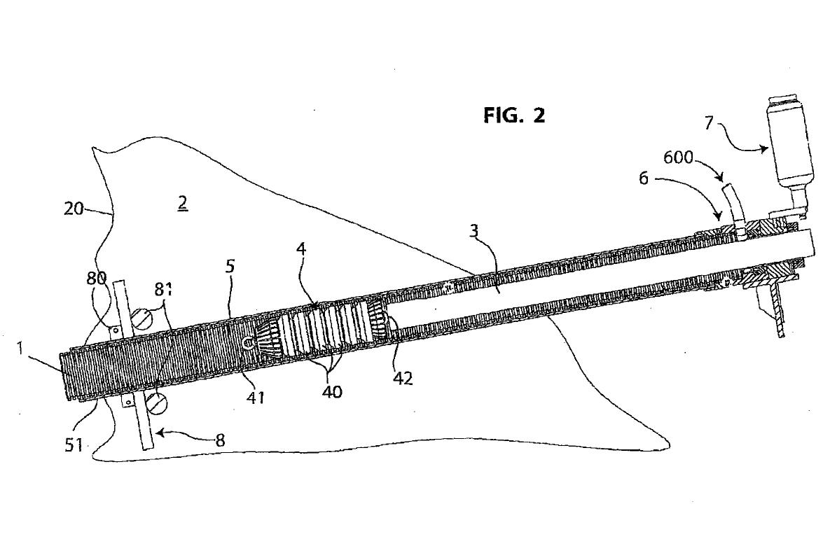

FIG. 2 is a cross-sectional view of the part of the laying device illustrated in FIG. 1.

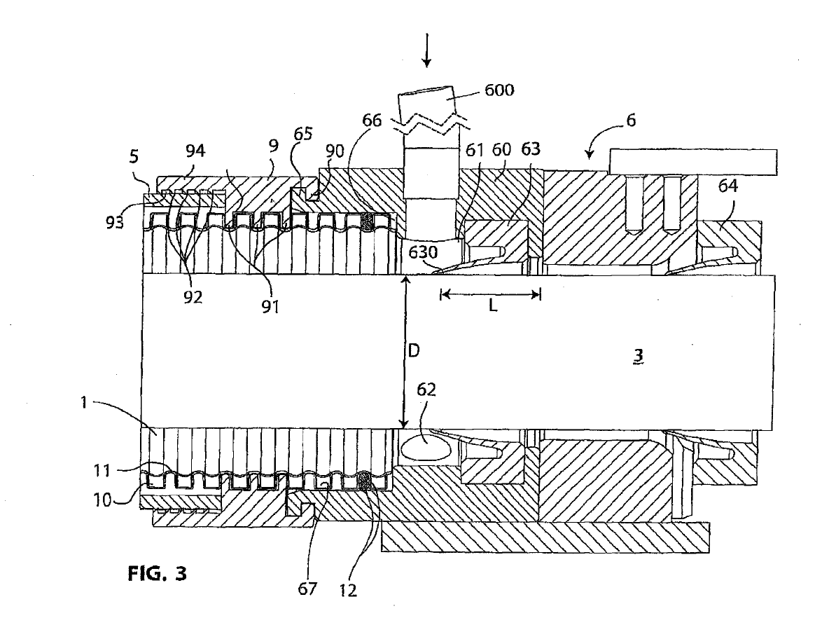

FIG. 3 is a detailed cross-sectional view of part of the laying device showing the water inlet device into the conduit.

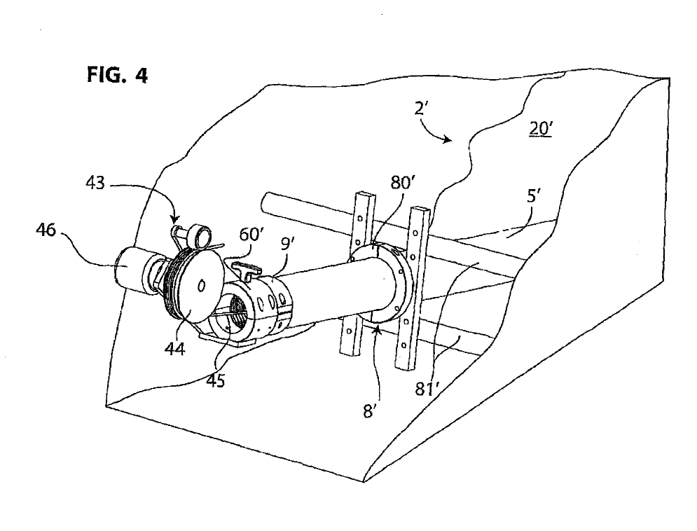

FIG. 4 is a perspective view of a downstream part of a device according to the invention to lay cable in a conduit.

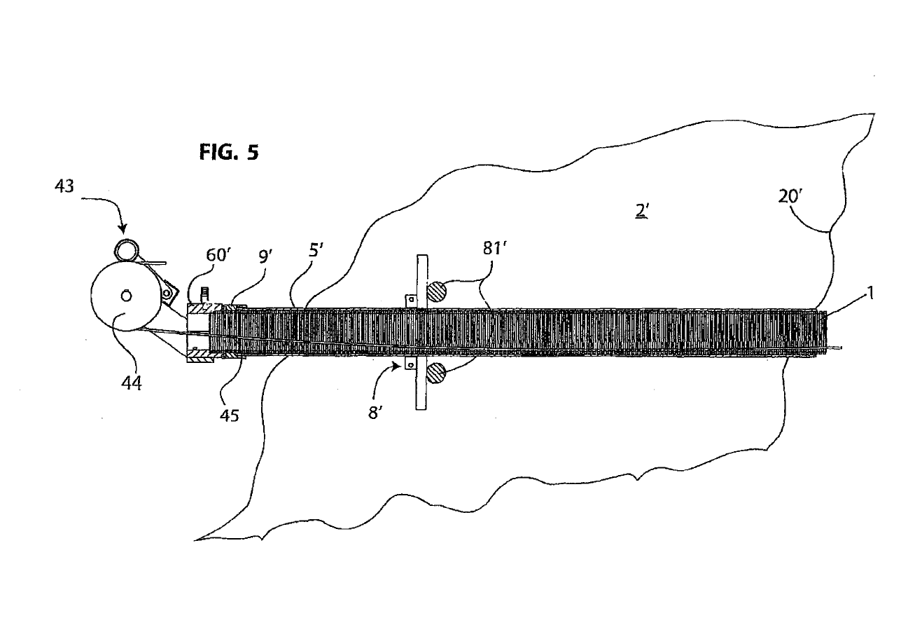

FIG. 5 is a cross-sectional view of the part of the laying device shown in FIG. 4.

The device is first described in a “pull-push” laying configuration, with pressurizing of the conduit for displacement of the piston.

With reference to the figures, there is a buried conduit 1 of ribbed type with twin wall, whose two ends each open into a trench 2, 2′ arranged to allow the laying of a cable or other element inside said conduit 1. It is noted in particular in FIGS. 2 and 5 that the conduit 1 protruding from the wall 20, 20′ of the trench extends over a certain length outside said wall 20, 20′.

Mere connection of a pressurizing installation onto a free end of the conduit 1 would, during the cable laying operation, lead to destruction of the non-buried portion of the conduit 1, by tearing and elongation of said portion.

To avoid this problem, a cable laying device 3 is used having a piston 4 and comprising a supporting sleeve 5, an attachment device 6 connected to a supply circuit 600 of pressurized fluid e.g. water, optionally a lubricant tank 7 and an anchor device 8. The cable laying device may also comprise a cable pushing and guide device (not illustrated) installed upstream from the attachment device 6. The push device is known per se, e.g. from EP 0 006 097 and will not be described in further detail. The piston 4 is also known per se, e.g. from EP 1 518 307, and comprises a plurality of seals with conical lips 40 able to withstand the pressure of the water injected into the conduit 1, and fastening means 41, 42 at the rear and front end of the piston for fastening to the cable and optionally to a winch line (not illustrated in this figure).

Referring especially to FIG. 3, the attachment device 6 comprises an attachment body 60, here defining a fluid inlet chamber 61 communicating with a fluid inlet 62 in which water or another fluid is injected under pressure towards inside the conduit (1). The attachment body 60 is connected to outside piping 600 which supplies the pressurized fluid.

The attachment device 6 also comprises a seal 63 intended to surround the cable to be laid 3 and to make the fluid inlet chamber 61 watertight with respect to the feed orifice for the cable into the device. The attachment device 6 may also comprise another seal 64, identical to seal 63, intended to hold back any water which may be sprayed in the direction of the push system (not illustrated).

A clamping member 9 is connected firstly to the conduit 1 and secondly to the attachment device 6, ensuring a rigid connection between these two elements. For this purpose, the clamping member 9 comprises an annular rim 90 mating with an annular rim 65 of the attachment body 60 to couple the clamping member 9 to said attachment body 60, as well as annular ridges and grooves 91 whose shape match the ribs of the conduit 1, so as to follow the outer contour of the ribbed conduit and fit between the ribs, as well as teeth or annular clamping elements 92 projecting from an inner peripheral surface 93 of an annular extension 94 for securing to the supporting sleeve 5.

The laying conduit 1 comprises a ribbed outer wall 10 and a corrugated inner wall 11 welded to the outer wall 10. The twin wall and in particular the ribs impart good radial pressure resistance to the conduits with respect to the thickness of the walls i.e. the weight of the material (here polymer) per conduit length. When the conduit is buried, the earth surrounding the conduit increases pressure strength. Said conduit does not however withstand high pressure if it is not buried, on account of its relatively low resistance to elongation. Pressure inside the conduit effectively generates a tensile force in the inner wall 11, the outer ribbed wall offering little or no resistance to tensile forces. When the conduit is buried, the earth surrounding the ribbing of the outer wall nevertheless imparts radial and axial strength to this outer wall, thereby overcoming this problem of conduit elongation. Also, to solve this problem, the laying device comprises a supporting sleeve 5 which may for example be a smooth, plastic, tube with a sufficiently thick and rigid wall to withstand water pressure inside the laying conduit. The inner diameter of the supporting sleeve 5 is therefore slightly greater than the outer diameter of the ribbed conduit 1, and its length is sufficient to sleeve the entire unburied length of the conduit 1.

Therefore by means of the supporting sleeve 5, that part of the laying conduit that is not buried and required for the cable laying and water injection systems, remains straight and does not become elongated under the pressure of the water injected into the conduit. For this purpose, the conduit 1 is secured to the supporting sleeve 5 by the clamping member 9 described above and by the abutment afforded by the ring-shaped surface 66 arranged inside the attachment body 60.

Preferably, the laying device is anchored to the ground by the anchor device 8 which, in this example, comprises a flange 80 secured to the supporting sleeve 5 and engaging with anchor bars 81 or other anchor elements fixed to the ground. However it is also possible to consider anchoring the pusher machine to the ground, or to arrange the anchor device 8 at any point on the sleeve 5 or on the attachment device 6. Preferably, it is attached in the vicinity of the free end of the sleeve 5, opposite the end joined to the attachment device 6.

As can be seen in FIG. 2, the end 51 of the supporting sleeve is preferably engaged in the ground surrounding the conduit, i.e. buried, so that no part of the conduit 1 is without a sleeve. It is to be pointed out that one of the characteristics of the ribbed conduit with twin wall is that it can be bent to have a relatively small radius of curvature compared with a smooth conduit, but this characteristic is a disadvantage if the conduit is under pressure without a support since it will have a tendency to bend and elongate on one side only. The supporting sleeve 5 therefore prevents the laying conduit 1 from bending and elongating on one side.

Anchoring of the machine and/or supporting sleeve 5 via the securing afforded by the clamping member 9 and the abutment 66 described above, avoids elongation of the conduit under pressure.

The cable 3 can be of circular section, but may also have other shapes such as essentially triangular (for example for three-phase cables) or essentially square. The cables may also have twisted conductors. This raises the problem of water tightness when feeding cable into a laying device based on injection of a fluid to drive the piston 4.

To guarantee water tightness of any shape of cable, the seal 63 is in the form of a lip seal, the lip 630 being slender and having a length L such that the ratio of this length over the mean diameter or width of the cable is at least 0.3 (L/D>0.3). The periphery of the end of the lip 630 is chosen to be shorter than the periphery of a cable section, preferably 5 to 10% shorter, so that it is under elastic tensile force around the cable. The lubricant tank 7 can supply a lubricant, e.g. containing silicon, to protect the lips of the seal 63 and reduce friction forces between the seal and the cable. To contain any sprays of water, a second seal 64 upstream of the first seal 63 can be provided, this second seal possibly having essentially the same construction as the first.

To ensure a seal between the attachment device 6 and the laying conduit 1, one or more seals are arranged in one or more ribs of the outer wall 10 of the laying conduit these seals 12 elastically bearing against the inner peripheral surface 67 of the body 60. These seals 12 may for example be in the form of an O-ring or a pair of O-rings, one arranged on the other so that they have increased radial elasticity to take into account the relatively low resistance of the inner wall 11 of the conduit on which these O-rings bear.

The attachment body 60 and the clamping member 9, with the exception of seals 63, 64, 12, can advantageously be made in two parts so that they can de disassembled and assembled around the conduit and supporting sleeve.

With reference now to FIGS. 4 and 5, the downstream end of the laying conduit can be seen. Those components arranged on this downstream portion which are of the same type as those mentioned previously, are designated by the same number followed by symbol ′. To increase cable laying distance, this part of the installation may advantageously comprise an auxiliary pulling device 43 comprising a reel 44 winding a pulling line 45 driven by an engine 46. The line 45 is attached at its free end by securing means 41 to the front end of the piston 4.

The motor 46 is advantageously servo-controlled to apply a specific and controlled traction force on the pulling line 45, and hence on the cable 3. The traction applied to the cable 3 can be constant and limited to a limit value empirically determined to avoid damaging the ribbed conduit through friction with the pulling line 45. Alternatively, the traction force applied by the engine can be controlled so that traction torque increases with the length of wound pulling line, since the closer the piston draws to the downstream end of the conduit the shorter the cable and the lesser the risk of damage. Also the force required to pull the cable to be laid increases as the cable progresses through the conduit.

The simultaneous use of several cable laying techniques namely cable pushing, water flowing, the pushing pressure applied by water and the pulling force applied by the traction line, together allow the cable laying distance to be maximized.

To withstand the fluid injection pressure when the piston arrives at the downstream end of the conduit 1′, and the loads applied by the pulling line, the downstream part of the laying conduit that is not buried is also provided with a supporting sleeve 5′ and anchor device 8′, 81′, similar to supporting sleeve 5, with respect to anchor device 8, at the upstream part. The end of the supporting sleeve 5 is secured to a conduit clamping member 9′ similar to clamping member 9 described previously, securing the supporting sleeve to a body 60′ on which the auxiliary traction device 43 is mounted.

While the laying device is particularly suitable for a laying technique comprising water pressurization of the conduit 1, it can just as well be used for a blowing method using pressurized air or a “carry-push” method. Similarly, it can be beneficially applied to a method not requiring pressurization of the conduit 1, i.e. using a “pull-push” method for example, the supporting sleeve 5 then being used for transfer of the mechanical reaction loads when the cable is being pushed, thereby avoiding damage to the unburied portion of the conduit 1.

1. Device for laying cable in a buried conduit of ribbed type with thin walls, comprising a pushing device for said cable, and
a supporting sleeve comprising attachment elements to attach a free non-buried end of said conduit of ribbed, thin-wall type, said sleeve being capable of preventing radial expansion of said conduit, while said attachments elements are capable of preventing elongation of the non-buried portion of said conduit, arranged downstream of the pusher device for said cable.

2. Device to lay cable according to claim 1, including a fluid inlet device connected to said supporting sleeve via an attachment body to place under pressure said conduit of ribbed, thin-wall type, so as to push a piston connected to the front end of the cable along said conduit.

3. Device to lay cable according to claim 1, including a lubricant tank connected to said sleeve.

4. Device to lay cable claim 1, including an anchor device secured to said sleeve, capable of securing said sleeve in position relative to the ground.

5. Device to lay cable according to claim 1, wherein the inner diameter of the supporting sleeve is slightly greater than the outer diameter of said conduit.

6. Device to lay cable according to claim 1, wherein the supporting sleeve coupled to the attachment elements is of sufficient length to sleeve at least the entire non-buried length of said conduit.

7. Device to lay cable according to claim 1, wherein the attachment elements to attach one free, non-buried end of said conduit comprise:
a clamping member comprising an annular rim mating with another matching annular rim of the attachment body to secure said clamping member to said attachment body,
annular ridges and grooves mating with the ribs of the conduit capable of fitting between said ribs,
annular clamping members projecting from an inner peripheral surface of an annular extension of said clamping member, capable of clamping and securing one end of the supporting sleeve, and
an abutment in the form of a circular ring adjoining said attachment body.

8. Device to lay cable according to claim 1, wherein the attachment device elements include at least one lip seal surrounding the cable to make a fluid inlet chamber watertight relative to the outside of the device, said seal having a slender lip of essentially tapered shape, the ratio between the length of the lip (L) and the minimum diameter (D) of the cable being greater than 0.3.

9. Device to lay cable according to claim 1, wherein the attachment device elements include a seal consisting of one or a pair of superimposed O-rings arranged between an inner peripheral surface of the attachment body and an outer wall of said conduit, between two ribs.

10. Device to lay cable according to claim 1, wherein a second supporting sleeve is arranged so as to protect the other non-buried end downstream of said conduit.

11. Device to lay cable according to claim 10, wherein the second supporting sleeve comprises a pulling device to pull a winch line attached to said piston.
